(19) United States
(12) Patent Application Publication
(10) Pub. No.: US 2026/0253492 A1
(43) Pub. Date: Aug. 27, 2026

(54) SMART POWER-SAVING SYSTEM OF TRAFFIC INFORMATION ELECTRONIC DISPLAY BOARD

(71) Applicants: Chang KIM, Seoul (KR); Que One KIM, Seoul (KR)

(72) Inventors: Chang KIM, Seoul (KR); Que One KIM, Seoul (KR)

(21) Appl. No.: 19/652,318

(22) Filed: Apr. 20, 2026

Related U.S. Application Data
(63) Continuation of application No. PCT/KR2024/016220, filed on Oct. 23, 2024.

(30) Foreign Application Priority Data
Oct. 24, 2023 (KR) 20-2023-0002162
Jan. 15, 2024 (KR) 20-2024-0000080

(51) Int. Cl. G08G 1/09; G08G 1/04; G09G 3/32

(52) U.S. Cl. CPC G08G 1/09; G08G 1/04; G09G 3/32; G09G 2320/0626; G09G 2330/021; G09G 2380/10

(57) ABSTRACT

Provided is a smart power-saving system of a traffic information electronic display board, which adjusts the brightness of the electronic display board according to a signal of a passing vehicle detected by an operation detection sensor such as a radar sensor, to maintain power-saving brightness at a minimum power when there is no passing vehicle, and to display, when a passing vehicle is detected, normal brightness up until the passing vehicle has passed the electronic display board, and then automatically return to the power-saving brightness, thereby reducing the power consumption of the electronic display board during times when there are no passing vehicles.

### TECHNICAL FIELD

The present invention relates to a smart power-saving system of a traffic information electronic display board. More particularly, the present invention relates to a smart power-saving system of a traffic information electronic display board configured to perform control such that the traffic information electronic display board displays information at power-saving luminance requiring minimum power when no vehicles are present based on a traffic signal detected by a motion detection sensors such as a radar sensor and such that, when a vehicle is detected, the traffic information electronic display board displays the information at normal luminance only until the vehicle passes the traffic information electronic display board and then automatically returns the luminance of the traffic information electronic display board to the power-saving luminance, thereby reducing the power consumption of the traffic information electronic display board during periods when no vehicles are present.

### BACKGROUND ART

There are two types of traffic information electronic display boards on national highways and expressways: a variable message sign (VMS), which is installed on the main lanes of national highways and expressways to provide traffic information to drivers) and a lane control system (LCS), which is installed in tunnels or on road shoulders to guide smooth traffic flow by indicating whether reversible lanes are open, speed limits, and other information.

In addition, there is a variable speed limit (VSL) sign, which imposes speed limits in stages based on traffic conditions to prevent congestion or accidents. Generally, the variable speed limit sign is a system that dynamically displays speed limits according to road conditions, guiding vehicles to drive safely at speeds lower than the speed limits. The variable speed limit sign, which is abbreviated as VSL, is also known as a variable speed limit system or a variable traffic guidance sign, which all refer to the same system.

However, these devices differ only in part in their names based on purpose and in some peripheral accessories, and have an identical basic operating structure of a system including an operation center control unit – a main control unit (MCU) – a video control unit (VCU) - display on an LED electronic display board.

The system configuration, specifications, and operating programs of the traffic information electronic display board and the variable speed limit (VSL) sign constitute a comprehensive, standardized system linked with various traffic information devices such as a CCTV and a highway vehicle detection system (VDS), and this system operates under a nationwide, unified management system 24 hours a day, 365 days a year.

The “maximum luminance” of the electronic display board refers to the white color at the highest luminance level, which consumes the most power. The “normal luminance” of the electronic display board is typically set at about 50 to 60% of the maximum luminance for each color as it is difficult for drivers to see information displayed on the LED electronic display board if the luminance of the electronic display board is too bright or too dark.

The “minimum luminance” of the electronic display board refers to a black color at the lowest luminance, which consumes the least power.

### Differences in System Configuration and Field Application

As shown in FIGS. 2 and 3, the prior art patents involve constituting a system by integrating vehicle detection signals and power-saving functions into a main control unit (MCU)/controller. This method, in which the main control unit (MCU) controls the system, necessitates changes to the program or operating system. Consequently, while the development concept is viable, it leads to a significant flaw that makes actual field application difficult.

Specifically, since the traffic information electronic display board provides comprehensive information by linking with other sources such as a highway vehicle detection system (VDS) and a CCTV, the traffic information electronic display board possesses the essential characteristic of being operated under a consistent, standardized system nationwide.

A power-saving system is efficient in mountainous or outlying areas with sparse traffic but may be inappropriate for areas with constant heavy traffic and congestion. Consequently, the efficiency of the power-saving system varies significantly depending on local conditions.

Due to these two conflicting characteristics, it is not possible to adopt a system that is efficient in a part of the country but unsuitable in others as a nationwide management system nor is it feasible to operate the existing system and the power-saving system separately depending on the area.

Consequently, the prior art patents configured such that control is performed by the main control unit have the problem that, although the development concept is viable, actual field application is not possible.

The prior art patents, in which the main control unit (MCU) controls the system, require selecting either the existing system or a modified power-saving mode as the operating system. However, since there are regions where applying the power-saving system is beneficial and others where it is not, it is difficult to apply the prior art patents to actual sites due to the nature of the nationwide management system.

In other words, there is a need to resolve the conventional problem that actual field application is difficult due to the difficulty of changing the operating system of the main control unit (MCU) when altering the conventional system configuration in which the main control unit (MCU) controls the system.

### Technical Problem

First, a conventional traffic information electronic display board (hereinafter referred to as an “electronic display board”) operates at full capacity 24 hours a day, 365 days a year, even when there is no traffic, whereby power is unnecessarily wasted. To address this issue, the present invention aims to eliminate unnecessary power waste by normally operating the electronic display board only when vehicles are present and maintaining a power-saving mode requiring minimum power when no vehicles are present.

Second, the present invention proposes a new system in which a luminance control device controls only power saving/normal luminance of display information, controlled by a main control unit (MCU), through a video control unit (VCU), thereby improving power-saving performance, wherein the new system is selectively used only in areas where the power-saving function is desirable while the existing operating system is maintained without modification to resolve the previous issue of being unable to apply the system to specific sites due to the nature of the nationwide management system.

To resolve this issue, the present invention proposes a new system in which a luminance control device controls only power saving/normal luminance of display information, controlled by a main control unit (MCU), through a video control unit (VCU), wherein the new system is selectively used only in areas where the power-saving function is desirable while the existing operating system is maintained without modification.

Third, in the prior art patents in which the main control unit (MCU) of the operation center control unit controls the system, modification of the operating program is unavoidable. However, since areas where the power-saving system is beneficial coexist with those where it is not, it is difficult to implement uniform modification using a standardized program under a nationwide integrated system. To resolve this issue, the present invention proposes a system in which a vehicle detection signal is transmitted not to the main control unit (MCU) of the operation center control unit but to a video control unit (VCU) including a luminance control device.

### Technical Solution

As a means for achieving the above objects, the present invention is configured as follows:

Based on an existing traffic information electronic display board operating system,

a vehicle signal detection unit including a motion detection sensor, such as a radar sensor, and a remote wireless RF transmission module is installed 1 km ahead of a traffic information electronic display board, and a remote wireless communication device and a luminance control device that receive a vehicle detection signal are installed around the traffic information electronic display board.

The luminance control device is connected to a video control unit configured to support a graphic function based on the vehicle detection signal, and controls a luminance control function of the video control unit (VCU) such that information is displayed at power-saving luminance during normal times when no vehicle traffic is detected based on the vehicle detection signal from the vehicle signal detection unit.

When a vehicle signal is detected, the luminance control device performs control such that the information is displayed at normal luminance for a predetermined period of time after a vehicle passes and the luminance is automatically returned to the power-saving luminance.

If failure or malfunction occurs in the function of adjusting the luminance based on the vehicle detection signal from the vehicle signal detection unit, the luminance control device automatically disables a power-saving control function and performs control such that the display information controlled by a main control unit (MCU) is displayed at the normal luminance.

If an operation center control unit issues a warning or an alarm or wishes to display information on the traffic information electronic display board arbitrarily as needed, even though there are no abnormalities in the power-saving function as a whole, the luminance control device performs control such that the traffic information electronic display board displays the information at the normal luminance.

The vehicle signal detection unit includes at least one motion detection sensor, such as a LiDAR sensor, a stereo CCTV, or an ultrasonic sensor, in addition to the radar sensor.

The signal detected by the vehicle signal detection unit is transmitted to at least one device capable of remote communication over a distance of approximately 1 km, tailored to the surrounding conditions, such as using a wireless AP or an optical communication network, in addition to the remote wireless RF transmission module.

The vehicle signal detection unit is installed at a central divider or a road shoulder located 1 km ahead of the traffic information electronic display board, and it is more preferable for the vehicle signal detection unit to be provided in two or more in consideration of failure or malfunction of a motion detection function.

The luminance control device performs control such that the traffic information electronic display board displays the information at the normal luminance for a predetermined period of time based on the vehicle detection signal and performs control that the luminance is adjusted to the power-saving luminance and then the traffic information electronic display board displays the information at the power-saving luminance after the vehicle has passed the traffic information electronic display board. The predetermined period of time refers to the time calculated based on typical vehicle speeds on national highways or expressways, specifically the time from 1 km before the traffic information electronic display board until 15 seconds after the passing vehicle has passed the electronic display board.

The normal luminance is set to the same level as before, and the power-saving luminance is preferably set to black or a dark color close to black, resulting in a power-saving luminance of less than 3% to minimize power consumption.

A video control unit (VCU) including a luminance control device configured to directly receive a detection signal from a vehicle signal detection unit and to adjust the luminance of a traffic information electronic display board to normal or power-saving luminance performs control such that video data transmitted by a main control unit (MCU) is displayed on the traffic information electronic display board (LED) in an optimal state, directly receives the vehicle signal detected by the vehicle signal detection unit, performs control such that the traffic information electronic display board displays information at the power-saving luminance requiring minimal power when no vehicle signal is detected, performs control such that the traffic information electronic display board displays the information at the normal luminance for a predetermined period of time and automatically returns the luminance to the power-saving luminance 15 seconds after a vehicle has passed the traffic information electronic display board when the vehicle signal is detected, performs control such that the traffic information electronic display board displays the information at the normal luminance if failure or malfunction is detected in the function of adjusting the luminance based on the vehicle detection signal transmitted via the vehicle signal detection unit and the RF transmission module through a detection function of the sensor unit, and performs control such that the traffic information electronic display board displays the information at the normal luminance if an operation center control unit issues a warning or an alarm or wishes to display the information on the traffic information electronic display board arbitrarily as needed even though there are no abnormalities in the function of adjusting the luminance based on the vehicle detection signal transmitted via the vehicle signal detection unit and the RF transmission module.

The luminance control device may be installed separately between the main control unit and the video control unit or may be included in the video control unit so as to perform the function of the luminance control device.

### Advantageous Effects

First, the present invention minimizes unnecessary power consumption by operating the electronic display board at normal luminance only when there is traffic and maintaining a power-saving mode requiring minimum power such that the electronic display board is operated at power-saving luminance when there is no traffic.

Second, the present invention achieves the desired power-saving effects simply by adding the luminance control device without modifying the existing operating system or programs. This eliminates the stabilization phase typically required for system changes and allows for the construction of a smart power-saving system at minimal expense, thereby offering significant labor and cost savings.

Third, in the present invention, since the luminance control device is connected to a video control unit VCU that supports a graphic function based on a vehicle detection signal and controls only power saving/normal luminance, it is possible to establish a power-saving system by operating such a separate luminance control device without modifying the operating system of the existing main control unit (MCU).

Fourth, the present invention achieves the desired results by integrating the luminance control device into the video control unit (VCU) to constitute a “device having a power-saving function” without modifying the existing operating system or programs. This eliminates the stabilization phase typically required when modifying the system, and since operation is performed in the state in which the luminance control device is included in the video control unit (VCU), it is possible to directly receive and process the vehicle signal detected by the vehicle signal detection unit, resulting in faster video control.

### DESCRIPTION OF DRAWINGS

FIG. 1 is a conceptual view of a conventional “traffic information electronic display board operating system” currently in use.

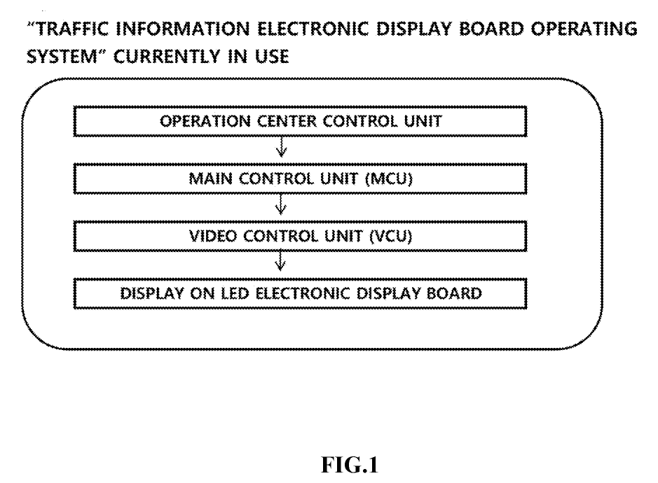

FIG. 2 is a system conceptual view of an “LED electronic display board luminance control device for expressways” of Prior Art Patent No. 10-2377216 (Patent Document 001).

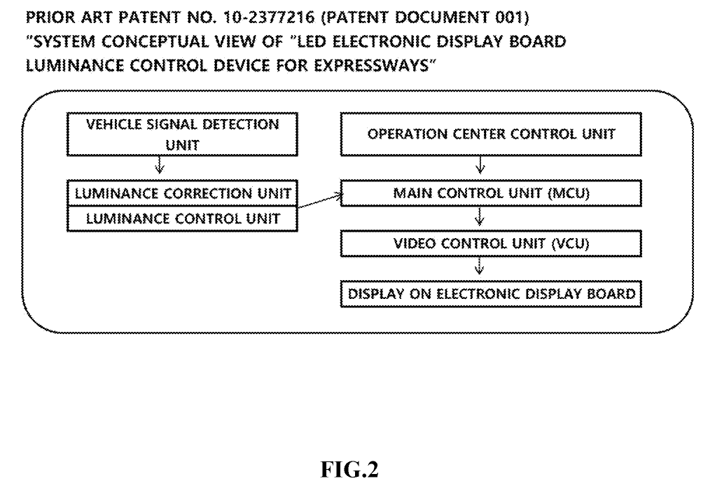

FIG. 3 is a conceptual view of an “artificial intelligence-based LED electronic display board control system for power saving” of Prior Art Patent No. 10-2497852 (Patent Document 002).

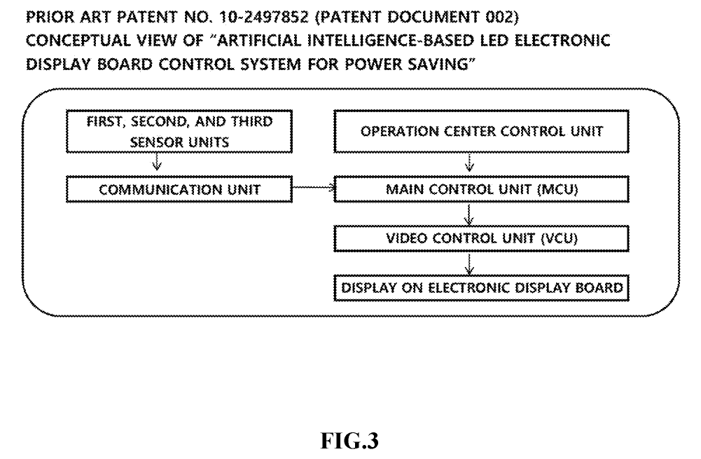

FIG. 4 is a conceptual view of a “power-saving system” to which a luminance control device according to an embodiment of the present invention is applied.

FIG. 5 is a configuration view of a “smart power-saving system of a traffic information electronic display board” to which a luminance control device is applied, according to an embodiment of the present invention.

FIG. 6 is a conceptual view of a “power-saving system” to which a luminance control device is applied in the state in which the luminance control device is included in a video control unit (VCU), according to another embodiment of the present invention.

Hereinafter, in order to describe the present invention in more detail, preferred embodiments of the present invention will be described in detail with reference to the accompanying drawings. Furthermore, the terms and words used in the specification and claims of the present application are defined appropriately by the inventors to describe the invention in the best possible manner; they should not be interpreted solely in their conventional or dictionary meanings, but rather in accordance with the meaning and concepts consistent with the technical concept of the present invention.

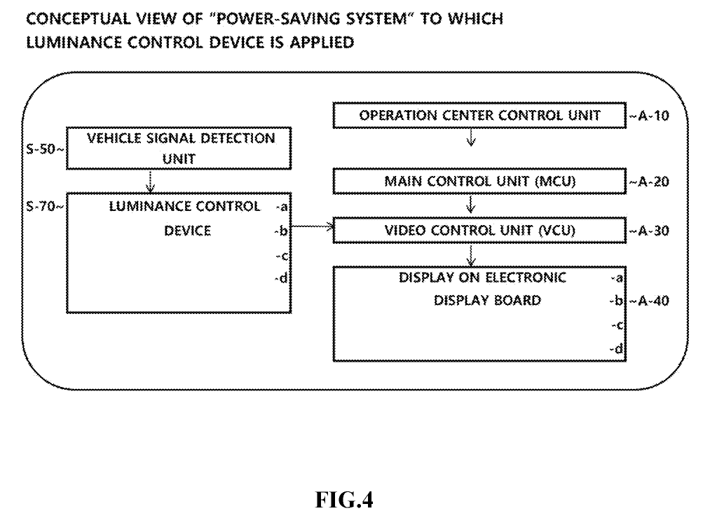

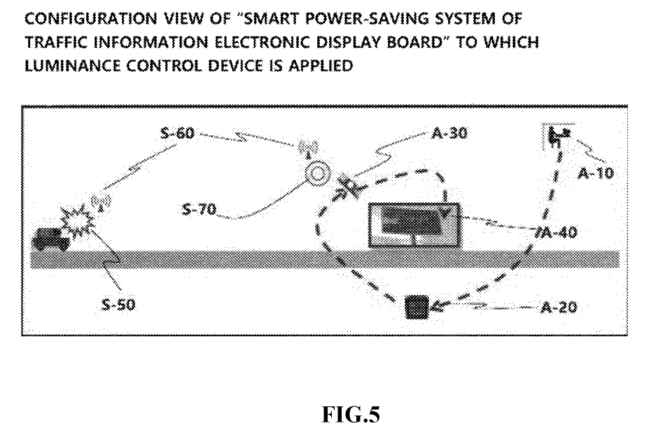

FIGS. 4 and 5 are configuration views of a “smart power-saving system of a traffic information electronic display board” to which a luminance control device is applied.

As shown in FIGS. 4 and 5, the smart power-saving system is based on an existing traffic information electronic display board operating system.

The smart power-saving system includes a vehicle signal detection unit S-50 equipped with a motion detection sensor such as a radar sensor, a remote wireless communication device S-60 such as a remote wireless RF transmission module, a luminance control device S-70 that is connected to a video control unit that supports a graphic function based on a vehicle detection signal and directly receives a vehicle signal from the vehicle signal detection unit, an operation center control unit A-10, a main control unit A-20, a traffic information electronic display board A-40, and a video control unit A-30 of the traffic information electronic display board.

The main control unit A-20 controls the system through a program/operating system.

The vehicle signal detection unit S-50 includes at least one motion detection sensor, such as a LiDAR sensor, a stereo CCTV, or an ultrasonic sensor, in addition to the radar sensor.

The vehicle signal detection unit is installed at a central divider or a road shoulder located 1 km ahead of the traffic information electronic display board A-40, and it is more preferable to install two or more vehicle signal detection units S-50 in consideration of failure or malfunction of a motion detection function.

The remote wireless communication device S-60 adopts at least one method capable of remote communication over a distance of approximately 1 km, tailored to the surrounding conditions, such as using a wireless AP or an optical communication network, in addition to the remote wireless RF transmission module.

The luminance control device S-70 is connected to a video control unit that supports a graphic function based on a vehicle detection signal, and displays information on the traffic information electronic display board at the lowest luminance level during normal times when there is no vehicle traffic based on a vehicle detection signal from the vehicle signal detection unit.

When a vehicle signal is detected, the display is set to normal luminance only for a certain period during the vehicle’s passage, after which the display automatically reverts to power-saving luminance.

In the present invention, the main control unit A-20 controls the system based on the display information received from the operation center control unit A-10.

In a configuration in which the traffic information electronic display board A-40 displays content based on video data received by the video control unit A-30 from the main control unit A-20 after video processing, the luminance control device S-70 controls the video control unit (VCU) based on a vehicle detection signal to adjust normal/power-saving luminance.

As shown in the conceptual view of FIG. 4 showing the power-saving system to which the luminance control device is applied, the luminance control device S-70 performs the function of adjusting the power saving/normal luminance of the traffic information electronic display board A-40 through the video control unit (VCU) A-30, which supports a graphic function based on a vehicle detection signal, regarding the display information controlled by the main control unit (MCU) A-20.

During normal times when there is no vehicle traffic, the vehicle signal detection unit S-50 detects the absence of traffic, and the luminance control device S-70-a maintains power-saving luminance, which consumes the least power, for the traffic information electronic display board A-40, while the system continues to operate under the same configuration as before.

When a vehicle signal is detected through the vehicle signal detection unit S-50, the luminance control device S-70-b performs a function of displaying the electronic display board at normal luminance for a predetermined period of time and then automatically returning to power-saving luminance after the vehicle has passed the electronic display board (A-40-b) while the system operates under the same configuration as before.

Here, the predetermined period of time refers to the time calculated based on typical vehicle speeds on national highways or expressways, specifically the time from 1 km before the traffic information electronic display board until 15 seconds after the passing vehicle has passed the electronic display board.

If failure or malfunction occurs in the function of the luminance control device that adjusts the luminance based on the vehicle detection signal from the vehicle signal detection unit S-50, the luminance control device S-70-c automatically disables the power-saving control function and performs control such that the traffic information electronic display board A-40 displays the information at the original normal luminance thereof (A-40-c).

If the operation center control unit issues a warning or an alarm or wishes to display information on the traffic information electronic display board A-40 arbitrarily as needed, even though there are no abnormalities in the power-saving function as a whole, the luminance control device S-70-d performs control such that the electronic display board A-40-d displays the information at normal luminance.

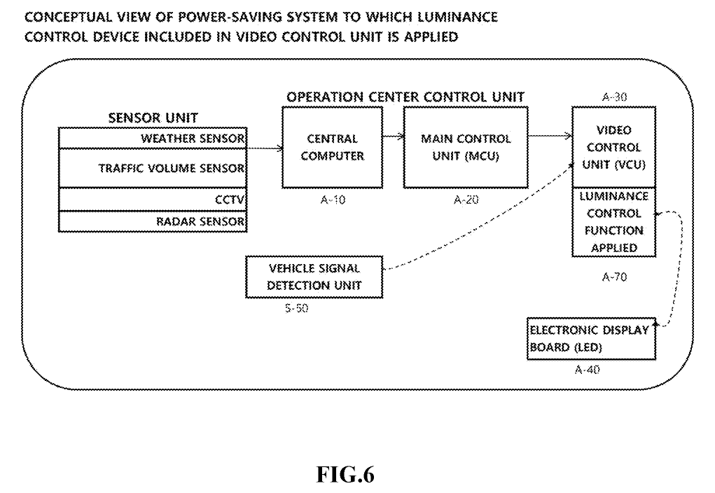

FIG. 6 is a conceptual view of a “power-saving system” to which a luminance control device is applied in the state in which the luminance control device is included in a video control unit (VCU), according to another embodiment of the present invention.

As shown in FIG. 6, a vehicle signal detection unit S-50 includes a radar sensor and a remote wireless RF transmission module.

The vehicle signal detection unit S-50 is installed at a central divider or a road shoulder located 1 km ahead of a traffic information electronic display board A-40.

A video control unit (VCU) A-30 of the traffic information electronic display board A-40 is modified into a “device having a power-saving function” that adjusts the luminance to perform display at normal or power-saving luminance based on a vehicle detection signal.

By directly connecting the vehicle detection signal to the “video control unit (VCU) A-30 having the power-saving function,” only the display of the traffic information electronic display board A-40 is adjusted to normal/power-saving luminance without modifying the program of a main control unit (MCU) A-20.

During normal times when there is no vehicle traffic, the video control unit (VCU) A-30 having the power-saving function adjusts only the display on the traffic information electronic display board A-40 to the minimum power-saving luminance while the system continues to operate under the same configuration as before. When a vehicle signal is detected, the video control unit (VCU) A-30 drives the traffic information electronic display board A-40 at normal luminance for a predetermined period of time and then automatically returns the luminance to power-saving luminance 15 seconds after the vehicle has passed while the system continues to operate under the same configuration as before.

If failure or malfunction is detected in the function of the video control unit (VCU) A-30 having the power-saving function that adjusts luminance based on a vehicle detection signal, the power-saving control function is automatically disabled, and the traffic information electronic display board A-40 is adjusted to display information at the original normal luminance thereof. Even if there is no problem with the step of adjusting the luminance based on the vehicle detection signal, it is preferable for the video control unit (VCU) A-30 having the power-saving function to be adjusted to perform display at normal luminance when the operation center control unit issues a warning or an alarm or wishes to adjust/display the traffic information electronic display board A-40 arbitrarily as needed.

Here, it is preferable for the normal luminance to be set to the same luminance as the luminance when displaying under the existing operating system, and it is preferable for the power-saving luminance to be less than 3% of the display color’s luminance, resulting in output of black or a dark color close to black.

As a method of utilizing an existing sensor unit without installing a new vehicle signal detection unit S-50, it is preferable for a vehicle detection signal that determines the presence or absence of vehicles to be added to the vehicle information transmitted by the existing sensor unit to the main control unit (MCU) A-20 such that the video control unit (VCU), which includes a luminance control device A-70, adjusts only the display luminance of the traffic information electronic display board A-40 based on new information including the vehicle detection signal.

The luminance control device S-70 may be installed separately between the main control unit A-20 and the video control unit A-30 or may be included in the video control unit A-30 so as to perform the function of the luminance control device S-70.

What is claimed:

1. A smart power-saving system of a traffic information electronic display board, the smart power-saving system comprising:
a vehicle signal detection unit (S-50) installed 1 km ahead of a traffic information electronic display board (A-40), the vehicle signal detection unit comprising a motion detection sensor, such as a radar sensor, and a remote wireless RF transmission module;
a remote wireless communication device (S-60) configured to transmit and receive data to and from the remote wireless RF transmission module;
a luminance control device (S-70) connected to a video control unit (A-30) configured to support a graphic function based on a vehicle detection signal, the luminance control device being configured to perform control such that information is displayed at power-saving luminance during normal times when no vehicle traffic is detected and to perform control such that the information is displayed at normal luminance for a predetermined period of time after a vehicle passes and the luminance is automatically returned to the power-saving luminance when a vehicle signal is detected based on the vehicle detection signal from the vehicle signal detection unit;
a main control unit (A-20) configured to control the system through a program/operating system; and
a video control unit (A-30) configured to control the traffic information electronic display board (A-40) to display text and video content,
wherein, when there is no vehicle traffic based on the vehicle detection signal from the vehicle signal detection unit (S-50), the luminance control device (S-70) performs control such that the traffic information electronic display board (A-40-b) displays the information at the power-saving luminance,
wherein, when a vehicle signal is detected, the luminance control device (S-70-a) performs control such that the traffic information electronic display board (A-40-a) displays the information at normal luminance only for a predetermined period of time after the vehicle passes and then the luminance is automatically returned to the power-saving luminance,
wherein, if failure or malfunction occurs in the function of the luminance control device that adjusts the luminance based on the vehicle detection signal from the vehicle signal detection unit (S-50), the luminance control device (S-70) automatically disables a power-saving control function and performs control such that the traffic information electronic display board (A-40) displays the information at the original normal luminance thereof, and
wherein, if an operation center control unit (A-10) issues a warning or an alarm or wishes to display information on the traffic information electronic display board (A-40) arbitrarily as needed, even though there are no abnormalities in the power-saving function as a whole, the luminance control device (S-70) performs control such that the electronic display board (A-40-d) displays the information at the normal luminance.

2. The smart power-saving system according to claim 1, wherein, when a vehicle signal is detected based on the vehicle detection signal from the vehicle signal detection unit (S-50), the normal luminance of the luminance control device (S-70) is the same luminance as the luminance in displaying under an existing operating system, and the power-saving luminance is set to black or a dark color close to black, resulting in a power-saving luminance of less than 3%.

3. The smart power-saving system according to claim 1, wherein the vehicle signal detection unit (S-50) comprises at least one motion detection sensor, such as a LiDAR sensor, a stereo CCTV, or an ultrasonic sensor, in addition to the radar sensor, and the vehicle signal detection unit (S-50) is installed at a central divider or a road shoulder located 1 km ahead of the traffic information electronic display board, the vehicle signal detection unit being provided in two or more in consideration of failure or malfunction of a motion detection function.

4. A smart power-saving system of a traffic information electronic display board, the smart power-saving system comprising:
a luminance control device (A-70) configured to directly receive a detection signal from a vehicle signal detection unit (S-50) and to adjust the luminance of a traffic information electronic display board (A-40) to normal or power-saving luminance; and
a video control unit (VCU-A-30) including the luminance control device (A-70) performs control such that video data transmitted by a main control unit (MCU) is displayed on the traffic information electronic display board (A-40) in an optimal state,
wherein the video control unit directly receives the vehicle signal detected by the vehicle signal detection unit (S-50), performs control such that the traffic information electronic display board (A-40) displays information at the power-saving luminance requiring minimal power when no vehicle signal is detected, and performs control such that the traffic information electronic display board (A-40) displays the information at the normal luminance for a predetermined period of time and automatically returns the luminance to the power-saving luminance 15 seconds after a vehicle has passed the traffic information electronic display board (A-40) when the vehicle signal is detected,
wherein the video control unit performs control such that the traffic information electronic display board (A-40) displays the information at the normal luminance if failure or malfunction is detected in the function of adjusting the luminance based on the vehicle detection signal transmitted via the vehicle signal detection unit and the RF transmission module through a detection function of the luminance control device (A-70), and
wherein the video control unit performs control such that the traffic information electronic display board (A-40) displays the information at the normal luminance if an operation center control unit issues a warning or an alarm or wishes to display the information on the traffic information electronic display board arbitrarily as needed even though there are no abnormalities in the function of adjusting the luminance based on the vehicle detection signal transmitted via the vehicle signal detection unit and the RF transmission module.

5. The smart power-saving system according to claim 1, wherein the luminance control device (S-70) is installed separately between the main control unit (A-20) and the video control unit (A-30) or is included in the video control unit (A-30) so as to perform the function of the luminance control device (S-70).
